(19) United States
(12) Patent Application Publication
(10) Pub. No.: US 2023/0395901 A1
(43) Pub. Date: Dec. 7, 2023

(54) STORAGE SYSTEM CONFIGURED FOR USE WITH AN ENERGY MANAGEMENT SYSTEM

(71) Applicant: Enphase Energy, Inc., Petaluma, CA (US)

(72) Inventors: Zhen Alex HUANG, Pflugerville, TX (US); Chris Morrow Young, Round Rock, TX (US); Zhiwei WU, Round Rock, TX (US)

(21) Appl. No.: 18/196,061

(22) Filed: May 11, 2023

Related U.S. Application Data
(60) Provisional application No. 63/348,722, filed on Jun. 3, 2022.

(51) Int. Cl. H01M 10/659; H01M 10/658; H01M 10/6561; H01M 10/42

(52) U.S. Cl. CPC H01M 10/659; H01M 10/658; H01M 10/6561; H01M 10/425; H02J 3/32

(57) ABSTRACT

A storage system configured for use with an energy management system is provided and includes a battery having a plurality of cells and a propagation barrier comprising a first set of slabs, phase change material, an opening positioned adjacent the phase change material, a second set of slabs positioned between the first set of slabs and configured such that as temperature of an initiating cell increases, the phase change material absorbs energy and melts so that a previous volume occupied by the phase change material is replaced with air to create high temperature gradient that reduces adjacent cell temperature rise.

### CROSS-REFERENCE TO RELATED APPLICATIONS

The present application claims the benefit of and priority to U.S. Provisional Application Ser. No. 63/348,722, filed on Jun. 3, 2022, the entire contents of which is incorporated herein by reference.

### BACKGROUND

### Field of the Disclosure

Embodiments of the present disclosure generally relate to power systems and, more particularly, to storage systems configured for use with energy management systems.

### Description of the Related Art

Storage systems configured for use with energy management systems are known. Typically, the storage systems comprise one or more batteries that are configured for single-phase operation or three-phase operation. The one or more batteries comprise one or more cells. During operation, an uncontrollable thermal event, e.g., thermal runaway, can be caused when one of the cells (an initiating cell) reaches relatively high temperature. During thermal runaway, a chemical reaction can sometimes occur in the initiating cell. For example, the heat generated by the initiating cell can diffusively propagate to one or more adjacent cells, thus causing the one or more adjacent cells to also enter the same thermal runaway state. Such propagation can lead to excessive (unwanted) energy being released by the one or more adjacent cells in the thermal runaway state.

Therefore, the inventors have provided herein improved storage systems configured for use with energy management systems.

### SUMMARY

In accordance with some aspects of the present disclosure, a storage system configured for use with an energy management system comprises a battery having a plurality of cells and a propagation barrier comprising a first set of slabs, phase change material, an opening positioned adjacent the phase change material, a second set of slabs positioned between the first set of slabs and configured such that as temperature of an initiating cell increases, the phase change material absorbs energy and melts so that a previous volume occupied by the phase change material is replaced with air to create high temperature gradient that reduces adjacent cell temperature rise.

In accordance with some aspects of the present disclosure, an energy management system comprises a power source, a storage system connected to the power source, a battery having a plurality of cells, a propagation barrier comprising a first set of slabs, phase change material, an opening positioned adjacent the phase change material, a second set of slabs positioned between the first set of slabs and configured such that as temperature of an initiating cell increases, the phase change material absorbs energy and melts so that a previous volume occupied by the phase change material is replaced with air to create high temperature gradient that reduces adjacent cell temperature rise, and a controller connected to the power source, the storage system, a load center, and an interconnect device via a bus for converting DC power from the power sources to grid-compliant AC power, converting DC power from the battery to grid-compliant AC power, and converting AC power from the bus to DC output that is stored in the battery.

In accordance with some aspects of the present disclosure, a method of manufacturing a battery in a storage system configured for use with an energy management system comprises positioning a plurality cells adjacent to each other and positioning a propagation barrier adjacent to at least one cell of the plurality of cells, the propagation barrier comprising a first set of slabs, phase change material, an opening positioned adjacent the phase change material, a second set of slabs positioned between the first set of slabs and configured such that as temperature of an initiating cell increases, the phase change material absorbs energy and melts so that a previous volume occupied by the phase change material is replaced with air to create high temperature gradient that reduces adjacent cell temperature rise.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a block diagram of a system for power conversion, in accordance with at least some embodiments of the present disclosure;

FIG. 2 is a block diagram of an AC battery system, in accordance with at least some embodiments of the present disclosure;

FIG. 3 is a block diagram of a battery, in accordance with at least some embodiments of the present disclosure; and

FIG. 4 is a flowchart of a method for manufacturing a battery for use with a storage system configured for use with an energy management system, in accordance with at least one embodiment of the present disclosure.

### DETAILED DESCRIPTION

In accordance with the present disclosure, methods and apparatus configured for use with energy management systems are disclosed herein. For example, a storage system can comprise a battery having a plurality of cells and a propagation barrier. The propagation barrier can comprise a first set of slabs, phase change material, an opening positioned adjacent the phase change material, a second set of slabs positioned between the first set of slabs and configured such that as temperature of an initiating cell increases, the phase change material absorbs energy and melts so that a previous volume occupied by the phase change material is replaced with air to create high temperature gradient that reduces adjacent cell temperature rise. Compared to conventional methods and apparatus, the methods and apparatus described herein provide improved thermal management by substantially containing thermal runaway to an initiating cell such that propagation of thermal runaway to other cells is reduced, if not eliminated.

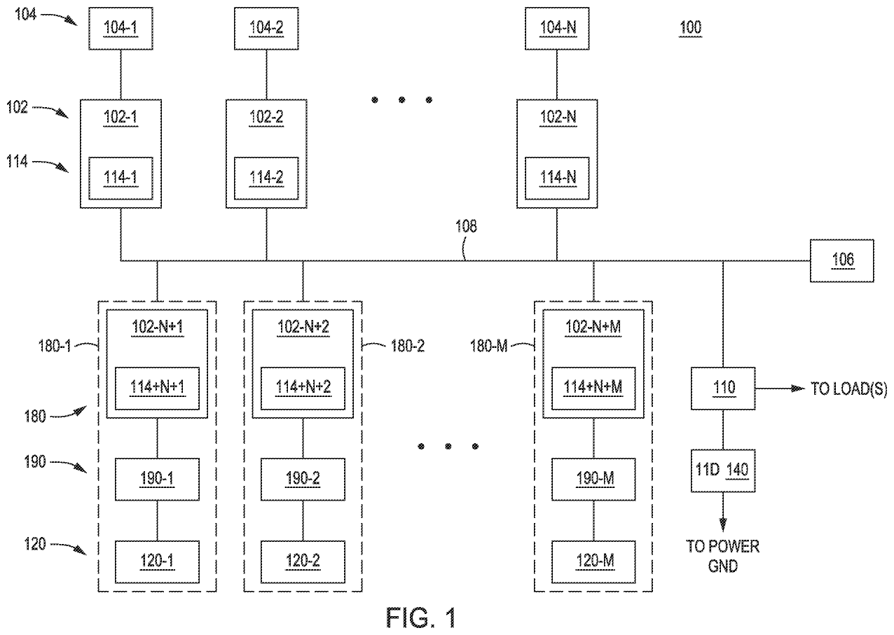

FIG. 1 is a block diagram of a system 100 (energy management system) for power conversion using one or more embodiments of the present disclosure. This diagram only portrays one variation of the myriad of possible system configurations and devices that may utilize the present disclosure.

The system 100 is a microgrid that can operate in both an islanded state and in a grid-connected state (i.e., when connected to another power grid (such as one or more other microgrids and/or a commercial power grid). The system 100 comprises a plurality of power converters 102-1, 102-2, . . . 102-N, 102-N+1, and 102-N+M collectively referred to as power converters 102 (which also may be called power conditioners); a plurality of DC power sources 104-1, 104-2, . . . 104-N, collectively referred to as power sources 104; a plurality of energy storage devices 120-1, 120-2, . . . 120-M collectively referred to as energy storage/delivery devices (or batteries 120); a system controller 106; a plurality of BMUs 190-1, 190-2, . . . 190-M collectively referred to as BMUs 190 (battery management units); a system controller 106; a bus 108; a load center 110; and an IID 140 (island interconnect device) (which may also be referred to as a microgrid interconnect device (MID)). In some embodiments, such as the embodiments described herein, the plurality of energy storage devices 120-1, 120-2, . . . 120-M are rechargeable batteries (e.g., multi-C-rate collection of AC batteries), although in other embodiments the energy storage/delivery devices may be any other suitable device for storing energy and providing the stored energy. Generally, each of the batteries comprises a plurality cells that are coupled in series, e.g., eight cells coupled in series to form a battery.

Each power converter 102-1, 102-2 . . . 102-N is coupled to a DC power source 104-1, 104-2 . . . 104-N, respectively, in a one-to-one correspondence, although in some other embodiments multiple DC power sources may be coupled to one or more of the power converters 102. The power converters 102-N+1, 102-N+2 . . . 102-N+M are respectively coupled to the plurality of energy storage devices 120-1, 120-2 . . . 120-M (delivery devices) via BMUs 190-1, 190-2 . . . 190-M to form AC batteries 180-1, 180-2 . . . 180-M, respectively. Each of the power converters 102-1, 102-2 . . . 102-N+M comprises a corresponding controller 114-1, 114-2 . . . 114-N+M (collectively referred to as the inverter controllers 114) for controlling operation of the power converters 102-1, 102-2 . . . 102-N+M.

In some embodiments, such as the embodiment described below, the DC power sources 104 are DC power sources and the power converters 102 are bidirectional inverters such that the power converters 102-1 . . . 102-N convert DC power from the DC power sources 104 to grid-compliant AC power that is coupled to the bus 108, and the power converters 102-N+1 . . . 102-N+M convert (during energy storage device discharge) DC power from the batteries 120 to grid-compliant AC power that is coupled to the bus 108 and also convert (during energy storage device charging) AC power from the bus 108 to DC output that is stored in the batteries 120 for subsequent use. The DC power sources 104 may be any suitable DC source, such as an output from a previous power conversion stage, a battery, a renewable energy source (e.g., a solar panel or photovoltaic (PV) module, a wind turbine, a hydroelectric system, or similar renewable energy source), or the like, for providing DC power. In other embodiments the power converters 102 may be other types of converters (such as DC-DC converters), and the bus 108 is a DC power bus.

The power converters 102 are coupled to the system controller 106 via the bus 108 (which also may be referred to as an AC line or a grid). The system controller 106 generally comprises a CPU coupled to each of support circuits and a memory that comprises a system control module for controlling some operational aspects of the system 100 and/or monitoring the system 100 (e.g., issuing certain command and control instructions to one or more of the power converters 102, collecting data related to the performance of the power converters 102, and the like). The system controller 106 is capable of communicating with the power converters 102 by wireless and/or wired communication (e.g., power line communication) for providing certain operative control and/or monitoring of the power converters 102.

In some embodiments, the system controller 106 may be a gateway that receives data (e.g., performance data) from the power converters 102 and communicates (e.g., via the Internet) the data and/or other information to a remote device or system, such as a master controller (not shown). Additionally or alternatively, the gateway may receive information from a remote device or system (not shown) and may communicate the information to the power converters 102 and/or use the information to generate control commands that are issued to the power converters 102.

The power converters 102 are coupled to the load center 110 via the bus 108, and the load center 110 is coupled to the power grid via the IID 140. When coupled to the power grid (e.g., a commercial grid or a larger microgrid) via the IID 140, the system 100 may be referred to as grid-connected; when disconnected from the power grid via the IID 140, the system 100 may be referred to as islanded. The IID 140 determines when to disconnect from/connect to the power grid (e.g., the IID 140 may detect a grid fluctuation, disturbance, outage or the like) and performs the disconnection/connection. Once disconnected from the power grid, the system 100 can continue to generate power as an intentional island, without imposing safety risks on any line workers that may be working on the grid, using the droop control techniques described herein. The IID 140 comprises a disconnect component (e.g., a disconnect relay) for physically disconnecting/connecting the system 100 from/to the power grid. In some embodiments, the IID 140 may additionally comprise an autoformer for coupling the system 100 to a split-phase load that may have a misbalance in it with some neutral current. In certain embodiments, the system controller 106 comprises the IID 140 or a portion of the IID 140.

The power converters 102 convert the DC power from the DC power sources 104 and discharging the batteries 120 (e.g., discharging batteries) to grid-compliant AC power and couple the generated output power to the load center 110 via the bus 108. The power is then distributed to one or more loads (for example to one or more appliances) and/or to the power grid (when connected to the power grid). Additionally or alternatively, the generated energy may be stored for later use, for example using batteries, heated water, hydro pumping, H₂O-to-hydrogen conversion, or the like. Generally, the system 100 is coupled to the commercial power grid, although in some embodiments the system 100 is completely separate from the commercial grid and operates as an independent microgrid.

In some embodiments, the AC power generated by the power converters 102 is single-phase AC power. In other embodiments, the power converters 102 generate three-phase AC power.

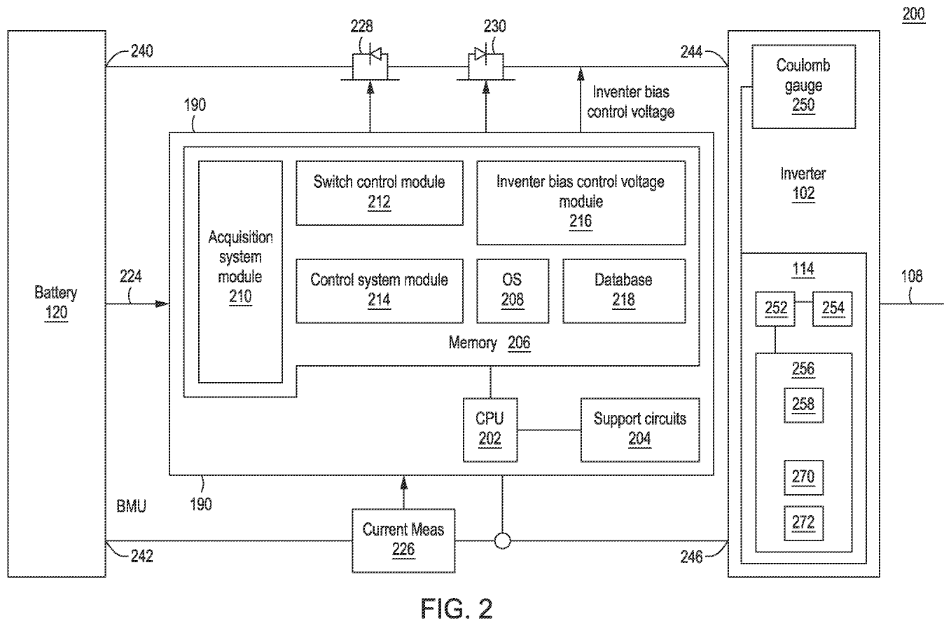

A storage system configured for use with an energy management system, such as the ENSEMBLE® energy management system available from ENPHASE®, is described herein. For example, FIG. 2 is a block diagram of an AC battery system 200 (e.g., a storage system) in accordance with one or more embodiments of the present disclosure.

The AC battery system 200 comprises a BMU 190 coupled to a battery (one or more of the batteries 120) and a power converter 102. A pair of metal-oxide-semiconductor field-effect transistors (MOSFETs) switches—switches 228 and 230—are coupled in series between a first terminal 240 of the battery and a first terminal of the inverter 144 such the body diode cathode terminal of the switch 228 is coupled to the first terminal 240 of the battery and the body diode cathode terminal of the switch 230 is coupled to the first terminal 244 of the power converter 102. The gate terminals of the switches 228 and 230 are coupled to the BMU 190.

A second terminal 242 of the battery is coupled to a second terminal 246 of the power converter 102 via a current measurement module 226 which measures the current flowing between the battery and the power converter 102.

The BMU 190 is coupled to the current measurement module 226 for receiving information on the measured current, and also receives an input 224 from the battery indicating the battery cell voltage and temperature. The BMU 190 is coupled to the gate terminals of each of the switches 228 and 230 for driving the switch 228 to control battery discharge and driving the switch 230 to control battery charge as described herein. The BMU 190 is also coupled across the first terminal 244 and the second terminal 246 for providing an inverter bias control voltage (which may also be referred to as a bias control voltage) to the inverter 102 as described further below.

The configuration of the body diodes of the switches 228 and 230 allows current to be blocked in one direction but not the other depending on state of each of the switches 228 and 230. When the switch 228 is active (i.e., on) while the switch 230 is inactive (i.e., off), battery discharge is enabled to allow current to flow from the battery to the power converter 102 through the body diode of the switch 230. When the switch 228 is inactive while the switch 230 is active, battery charge is enabled to allow current flow from the power converter 102 to the battery through the body diode of the switch 228. When both switches 228 and 230 are active, the system is in a normal mode where the battery can be charged or discharged.

The BMU 190 comprises support circuits 204 and a memory 206 (e.g., non-transitory computer readable storage medium), each coupled to a CPU 202 (central processing unit). The CPU 202 may comprise one or more processors, microprocessors, microcontrollers and combinations thereof configured to execute non-transient software instructions to perform various tasks in accordance with embodiments of the present disclosure. The CPU 202 may additionally or alternatively include one or more application specific integrated circuits (ASICs). In some embodiments, the CPU 202 may be a microcontroller comprising internal memory for storing controller firmware that, when executed, provides the controller functionality described herein. The BMU 190 may be implemented using a general purpose computer that, when executing particular software, becomes a specific purpose computer for performing various embodiments of the present disclosure.

The support circuits 204 are well known circuits used to promote functionality of the CPU 202. Such circuits include, but are not limited to, a cache, power supplies, clock circuits, buses, input/output (I/O) circuits, and the like. The BMU 190 may be implemented using a general purpose computer that, when executing particular software, becomes a specific purpose computer for performing various embodiments of the present disclosure. In one or more embodiments, the CPU 202 may be a microcontroller comprising internal memory for storing controller firmware that, when executed, provides the controller functionality described herein.

The memory 206 may comprise random access memory, read only memory, removable disk memory, flash memory, and various combinations of these types of memory. The memory 206 is sometimes referred to as main memory and may, in part, be used as cache memory or buffer memory. The memory 206 generally stores the OS 208 (operating system), if necessary, of the inverter controller 114 that can be supported by the CPU capabilities. In some embodiments, the OS 208 may be one of a number of commercially available operating systems such as, but not limited to, LINUX, Real-Time Operating System (RTOS), and the like.

The memory 206 stores non-transient processor-executable instructions and/or data that may be executed by and/or used by the CPU 202 to perform, for example, one or more methods for discharge protection, as described in greater detail below. These processor-executable instructions may comprise firmware, software, and the like, or some combination thereof. The memory 206 stores various forms of application software, such as an acquisition system module 210, a switch control module 212, a control system module 214, and an inverter bias control module 216. The memory 206 additionally stores a database 218 for storing data related to the operation of the BMU 190 and/or the present disclosure, such as one or more thresholds, equations, formulas, curves, and/or algorithms for the control techniques described herein. In various embodiments, one or more of the acquisition system module 210, the switch control module 212, the control system module 214, the inverter bias control module 216, and the database 218, or portions thereof, are implemented in software, firmware, hardware, or a combination thereof.

The acquisition system module 210 obtains the cell voltage and temperature information from the battery via the input 224, obtains the current measurements provided by the current measurement module 226, and provides the cell voltage, cell temperature, and measured current information to the control system module 214 for use as described herein.

The switch control module 212 drives the switches 228 and 230 as determined by the control system module 214. The control system module 214 provides various battery management functions, including protection functions (e.g., overcurrent (OC) protection, overtemperature (OT) protection, and hardware fault protection), metrology functions (e.g., averaging measured battery cell voltage and battery current over, for example, 100 ms to reject 50 and 60 Hz ripple), state of charge (SOC) analysis (e.g., coulomb gauge 250 for determining current flow and utilizing the current flow in estimating the battery SOC; synchronizing estimated SOC values to battery voltages (such as setting SOC to an upper bound, such as 100%, at maximum battery voltage; setting SOC to a lower bound, such as 0%, at a minimum battery voltage); turning off SOC if the power converter 102 never drives the battery to these limits; and the like), balancing (e.g., autonomously balancing the charge across all cells of a battery to be equal, which may be done at the end of charge, at the end of discharge, or in some embodiments both at the end of charge and the end of discharge). By establishing upper and lower estimated SOC bounds based on battery end of charge and end of discharge, respectively, and tracking the current flow and cell voltage (i.e., battery voltage) between these events, the BMU 190 determines the estimated SOC.

The inverter controller 114 comprises support circuits 254 and a memory 256, each coupled to a CPU 252 (central processing unit). The CPU 252 may comprise one or more processors, microprocessors, microcontrollers and combinations thereof configured to execute non-transient software instructions to perform various tasks in accordance with embodiments of the present disclosure. The CPU 252 may additionally or alternatively include one or more application specific integrated circuits (ASICs). In some embodiments, the CPU 252 may be a microcontroller comprising internal memory for storing controller firmware that, when executed, provides the controller functionality herein. The inverter controller 114 may be implemented using a general purpose computer that, when executing particular software, becomes a specific purpose computer for performing various embodiments of the present disclosure.

The support circuits 254 are well known circuits used to promote functionality of the CPU 252. Such circuits include, but are not limited to, a cache, power supplies, clock circuits, buses, input/output (I/O) circuits, and the like. The inverter controller 114 may be implemented using a general purpose computer that, when executing particular software, becomes a specific purpose computer for performing various embodiments of the present disclosure. In one or more embodiments, the CPU 252 may be a microcontroller comprising internal memory for storing controller firmware that, when executed, provides the controller functionality described herein.

The memory 256 may comprise random access memory, read only memory, removable disk memory, flash memory, and various combinations of these types of memory. The memory 256 is sometimes referred to as main memory and may, in part, be used as cache memory or buffer memory. The memory 256 generally stores the OS 258, if necessary, of the inverter controller 114 that can be supported by the CPU capabilities. In some embodiments, the OS 258 may be one of a number of commercially available operating systems such as, but not limited to, LINUX, Real-Time Operating System (RTOS), and the like.

The memory 256 stores non-transient processor-executable instructions and/or data that may be executed by and/or used by the CPU 252. These processor-executable instructions may comprise firmware, software, and the like, or some combination thereof. The memory 256 stores various forms of application software, such as a power conversion control module 270 for controlling the bidirectional power conversion, and a battery management control module 272.

The BMU 190 communicates with the system controller 106 to perform balancing of the batteries 120 (e.g., multi-C-rate collection of AC batteries) based on a time remaining before each of the batteries are depleted of charge, to perform droop control (semi-passive) which allows the batteries to run out of charge at substantially the same time, and perform control of the batteries to charge batteries having less time remaining before depletion using batteries having more time remaining before depletion, as described in greater detail below.

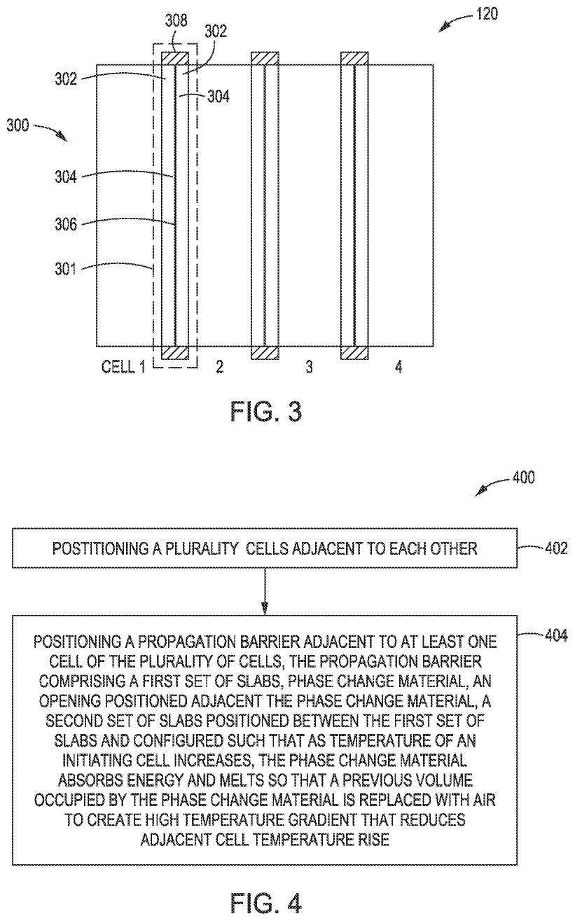

FIG. 3 is a block diagram of a battery (e.g., the plurality of energy storage devices 120-1, 120-2, . . . 120-M), in accordance with at least some embodiments of the present disclosure. The battery has a plurality of cells 300. One or more of the plurality of cells 300 can be in contact with a propagation barrier 301. For example, the propagation barrier 301 can be provided between any two cells of the plurality of cells 300. In at least some embodiments, each cell (e.g., cells 1 to 4) of the plurality of cells 300 is in contact with a propagation barrier 301. The propagation barrier 301 comprises a first set of slabs 302, phase change material 306, an opening 308 (or outlet), which can be positioned adjacent to the phase change material 306 and located on a top and/or bottom of each cell, and a second set of slabs 304 positioned between the first set of slabs 302.

The first set of slabs 302 can be made from one or more low thermal conductive materials. In at least some embodiments, the low thermal conductive material can be made from one of ceramic material, plastic material, or foam material.

The phase change material can be any suitable phase change material. For example, the phase change material can be formed from at least one of organic materials or salt hydrates. In at least some embodiments, the phase change material 306 can be at least one of bromcamphor C₁₀H₁₅BrO, glautaric acid C₃H₆(COOH)₂, or catechol C₆H₄(OH)₂. The phase change material 306 can be a solid at temperatures below 110° C. In at least some embodiments, the phase change material 306 can be a solid at temperatures below 90° C.

The second set of slabs 304 can be made from a reflective material. In at least some embodiments, the reflective material can be in the form of at least one of radiant foil or a radiant wrap. For example, the radiant foil can comprise a radiant barrier made of a thin layer of woven polyethylene which is sandwiched between two layers of a highly reflective metalized coating. Similarly, the radiant wrap can comprise two layers of polyethylene industrialized air bubbles bonded between two layers of highly reflective/white metalized aluminum polyester film. The radiant wrap has industrialized strength, is lightweight yet durable.

In use, the propagation barrier 301 is configured such that as temperature of an initiating cell increases, e.g., cell 3, the phase change material 306 absorbs energy and begins to melt. The previous volume occupied by the phase change material is replaced with air, which is one of the worst conducting materials and thus creates a high temperature gradient that reduces adjacent cell temperature rise. Additionally, the high reflectivity material of the second set of slabs 304 reflects radiation energy from passing to adjacent/neighboring cells, which, in turn, reduces, if not eliminates, thermal runaway propagation.

FIG. 4 is a flowchart of a method 400 of manufacturing a battery (e.g., one or more of the batteries 120) in a storage system configured for use with an energy management system, in accordance with at least one embodiment of the present disclosure. For example, during manufacture of the battery, at 402, the method 400 comprises positioning a plurality of cells 300 adjacent to each other (FIG. 3).

Next, at 404, the method 400 comprises positioning a propagation barrier 301 adjacent to at least one cell of the plurality of cells 300. As noted above, in at least some embodiments, the propagation barrier 301 can comprise a first set of slabs 302, phase change material 306, an opening 308 positioned adjacent the phase change material 306, a second set of slabs 304 positioned between the first set of slabs 302. The battery is configured such that as temperature of an initiating cell increases (cell 1 of FIG. 3), the phase change material 306 absorbs energy and melts so that a previous volume occupied by the phase change material 306 is replaced with air to create high temperature gradient that reduces adjacent cell (cell 2) temperature rise.

While the foregoing is directed to embodiments of the present disclosure, other and further embodiments of the disclosure may be devised without departing from the basic scope thereof, and the scope thereof is determined by the claims that follow.

1. A storage system configured for use with an energy management system, comprising:
a battery having a plurality of cells; and
a propagation barrier comprising a first set of slabs, phase change material, an opening positioned adjacent the phase change material, a second set of slabs positioned between the first set of slabs and configured such that as temperature of an initiating cell increases, the phase change material absorbs energy and melts so that a previous volume occupied by the phase change material is replaced with air to create high temperature gradient that reduces adjacent cell temperature rise.

2. The storage system of claim 1, wherein the first set of slabs are made from a low thermal conductive material.

3. The storage system of claim 2, wherein the low thermal conductive material is made from one of ceramic material, plastic material, or foam material.

4. The storage system of claim 3, wherein the phase change material is formed from at least one of organic materials or salt hydrates.

5. The storage system of claim 4, wherein the phase change material is at least one of bromcamphor, glautaric acid, or catechol.

6. The storage system of claim 1, wherein the second set of slabs are made from a reflective material.

7. The storage system of claim 6, wherein the reflective material is at least one of a radiant foil or a radiant wrap.

8. An energy management system, comprising:
a power source;
a storage system connected to the power source and comprising a battery having a plurality of cells and a propagation barrier comprising a first set of slabs, phase change material, an opening positioned adjacent the phase change material, a second set of slabs positioned between the first set of slabs and configured such that as temperature of an initiating cell increases, the phase change material absorbs energy and melts so that a previous volume occupied by the phase change material is replaced with air to create high temperature gradient that reduces adjacent cell temperature rise; and
a controller connected to the power source, the storage system, a load center, and an interconnect device via a bus for converting DC power from the power source to grid-compliant AC power, converting DC power from the battery to grid-compliant AC power, and converting AC power from the bus to DC output that is stored in the battery.

9. The energy management system of claim 8, wherein the first set of slabs are made from a low thermal conductive material. The energy management system of claim 9, wherein the low thermal conductive material is made from one of ceramic material, plastic material, or foam material.

11. The energy management system of claim 10, wherein the phase change material is formed from at least one of organic materials or salt hydrates.

12. The energy management system of claim 10, wherein the phase change material is at least one of bromcamphor, glautaric acid, or catechol.

13. The energy management system of claim 8, wherein the second set of slabs are made from a reflective material.

14. The energy management system of claim 13, wherein the reflective material is at least one of a radiant foil or a radiant wrap.

15. A method of manufacturing a battery in a storage system configured for use with an energy management system, the method comprising:
positioning a plurality of cells adjacent to each other; and
positioning a propagation barrier adjacent to at least one cell of the plurality of cells, the propagation barrier comprising a first set of slabs, phase change material, an opening positioned adjacent the phase change material, a second set of slabs positioned between the first set of slabs and configured such that as temperature of an initiating cell increases, the phase change material absorbs energy and melts so that a previous volume occupied by the phase change material is replaced with air to create high temperature gradient that reduces adjacent cell temperature rise.

16. The method of claim 15, wherein the first set of slabs are made from a low thermal conductive material.

17. The method of claim 16, wherein the low thermal conductive material is made from one of ceramic material, plastic material, or foam material.

18. The method of claim 17, wherein the phase change material is formed from at least one of organic materials or salt hydrates.

19. The method of claim 18, wherein the phase change material is at least one of bromcamphor, glautaric acid, or catechol.

20. The method of claim 15, wherein the second set of slabs are made from a reflective material.
